(19) United States
(12) Patent Application Publication
(10) Pub. No.: US 2025/0329838 A1
(43) Pub. Date: Oct. 23, 2025

(54) BATTERY ENERGY STORAGE SYSTEM

(71) Applicant: Our Next Energy, Inc., Novi, MI (US)

(72) Inventors: Mujeeb Ijaz, West Bloomfield, MI (US); Nathan Saliga, Clarkston, MI (US); Eric Cunningham, Brighton, MI (US); Emerson Miller, Northville, MI (US)

(21) Appl. No.: 19/169,847

(22) Filed: Apr. 3, 2025

Related U.S. Application Data
(60) Provisional application No. 63/574,094, filed on Apr. 3, 2024.

(51) Int. Cl. H01M 50/238; H01M 50/209; H01M 50/213; H01M 50/251; H01M 50/256; H01M 50/264; H01M 50/271; H01M 50/367; H01M 50/502

(52) U.S. Cl. CPC H01M 50/238; H01M 50/209; H01M 50/213; H01M 50/251; H01M 50/256; H01M 50/264; H01M 50/271; H01M 50/367; H01M 50/502

(57) ABSTRACT

A battery energy storage system including a housing, a top flange disposed at a top portion of the battery energy storage system, a bottom flange including a plenum, disposed at a bottom portion of the battery energy storage system, a middle web disposed between the top flange and the bottom flange, the middle web is defined by several modules arranged vertically in the housing, each of the modules including a module housing and a collection of cells. The top flange, the bottom flange, and the middle web define an I-beam structure of the battery energy storage system. A vent gas management system and a skip-module connection strategy are also disclosed.

### CROSS REFERENCE TO RELATED APPLICATIONS

This application claims the priority of U.S. Provisional Application No. 63/574,094, filed Apr. 3, 2024, the disclosure of which is incorporated by reference in its entirety for all purposes.

### BACKGROUND

### Technical Field

The present disclosure generally relates to a battery energy storage system, and more particularly, to features of a battery energy storage system constructed to optimize safety, module access and site energy density.

### Description of the Related Art

Electricity is commonly produced from power generation facilities like gas-fired, coal-fired, nuclear, and hydroelectric power plants, and distributed through a grid to users. The supply from these sources and the demand for electricity can fluctuate.

During peak demand, power interruptions, transmission constraints, or generator outages, backup energy storage systems may supplement electricity provided by the conventional sources.

### BRIEF SUMMARY

According to an embodiment of the present disclosure, a battery energy storage system is disclosed. The battery energy storage system comprises a housing, a top flange disposed at a top portion of the battery energy storage system, a bottom flange including a plenum, disposed at a bottom portion of the battery energy storage system, a middle web disposed between the top flange and the bottom flange, the middle web being defined by several modules arranged vertically in the housing, each of the modules including a module housing and a collection of cells. The top flange, the bottom flange, and the middle web define an I-beam structure of the battery energy storage system.

In one embodiment, the cells are cylindrical hollow core cells or top terminal prismatic cells.

In one embodiment, top flange comprises the top portion of the of modules, and connecting plates that joins adjacent modules together at the top portion.

In one embodiment, the modules are attached to the bottom flange, and the battery energy storage system is provided with a honeycomb structure that makes the battery energy storage system stiff when lifted. The honeycomb structure is produced by virtue of the connecting plates joining the modules together at the top portion to generate the top flange, the rigid module housings evenly spacing the top flange from the bottom flange, and the modules being removable attached to the bottom flange. This provides a predetermined resistance to bending of the battery energy storage system upon lifting of the battery energy storage system.

According to an embodiment of the present disclosure, a battery energy storage system is disclosed that comprises a housing, a bottom flange that including a plenum, the bottom flange id disposed at a bottom portion of the battery energy storage system and an escape duct connected to the bottom flange. Several modules are arranged vertically in the housing, each module including a module housing, a plurality of cells, and a module opening at a bottom portion of the module. The cells of the modules include vents through which vent gas and vent debris are disposed to the bottom flange through the module opening. Responsive to a venting event of the cells, the vent debris is held in the bottom flange and the vent gas is pushed through the escape duct by virtue of a minimized volume of the plenum.

According to an embodiment of the present disclosure, a battery energy storage system is disclosed that comprises a housing; several modules disposed vertically in the housing, each module including a module housing and a number of cells disposed in the module housing. The modules are arranged in at least one row, in a skip-module electrical architecture of odd designated modules interspersed in the at least one row with even designated modules to define two sets of modules. The two sets of modules are electrically coupled to generate two series strings of modules that maintain consistent connector lengths in the battery energy storage system.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a block diagram of a power supply environment including a network of data processing systems in accordance with an illustrative embodiment.

FIG. 2 depicts a block diagram of a data processing system in accordance with an illustrative embodiment.

FIG. 3 depicts a block diagram of a power supply system in accordance with an illustrative embodiment.

FIG. 4 depicts a perspective view of a module in accordance with an illustrative embodiment.

FIG. 5 depicts a perspective view of a battery energy storage system in accordance with an illustrative embodiment.

FIG. 6 depicts a cross section of a battery energy storage system with an illustrative embodiment.

FIG. 7 depicts a cross section of a battery energy storage system illustrating a honeycomb structure in accordance with an illustrative embodiment.

FIG. 8 depicts a cross section of a battery energy storage system illustrating a connection between four adjacent modules in accordance with one embodiment.

FIG. 9 depicts a perspective view of a battery energy storage system illustrating an internal structure in accordance with an illustrative embodiment.

FIG. 10 depicts a sketch illustrating roof access in accordance with an illustrative embodiment.

FIG. 11 depicts a sketch of a plant layout in accordance with an illustrative embodiment.

FIG. 12 depicts a perspective view of a battery energy storage system illustrating a nested roof structure in accordance with an illustrative embodiment.

FIG. 13 depicts a method in accordance with an illustrative embodiment.

FIG. 14 depicts a cross section of a battery energy storage system with an illustrative embodiment.

FIG. 15 depicts a cross section of a battery energy storage system with an illustrative embodiment.

FIG. 16 depicts a cross section of a battery energy storage system with an illustrative embodiment.

FIG. 17 depicts a sketch comparing benchmarks in accordance with an illustrative embodiment.

FIG. 18 depicts a method in accordance with an illustrative embodiment.

FIG. 19 depicts a top view of a battery energy storage system illustrating a connection strategy in accordance with an illustrative embodiment.

FIG. 20 depicts a method in accordance with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high level, without detail, to avoid unnecessarily obscuring aspects of the present teachings.

The illustrative embodiments recognize that sustainable, low-cost energy storage systems may be critical to the operation of a power grid. On one hand, electricity may be provided through primary sources such as gas-fired, coal-fired, nuclear, and hydroelectric power plants. One another hand, power interruptions and transmission constraints can affect the ability to deliver power at the right times. By configuring battery energy storage systems to optimize energy storage and power output, the operation of the power grid may be optimized through introduction of large-scale battery energy storage systems.

The illustrative embodiments disclose a battery energy storage system comprising a plurality of modules, each module comprising a plurality of hollow core cells, each hollow core cell including a hollow core. The plurality of modules is disposed adjacent to each other in between a top flange and a bottom flange of the battery energy storage system to define a honeycomb structure that provides a strength of the battery energy storage system. The battery energy storage system may further include a manifold structure configured to aid in a venting process of cells of the module. The battery energy storage system may also comprise coupling mechanism wherein modules are coupled to reduce a variation of resistances between modules.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

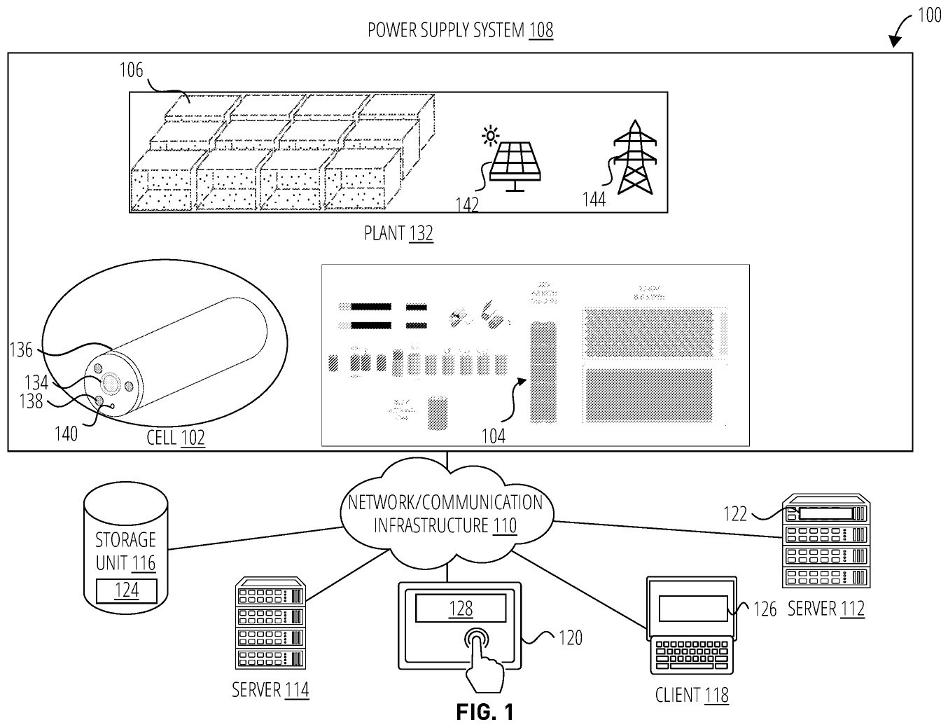

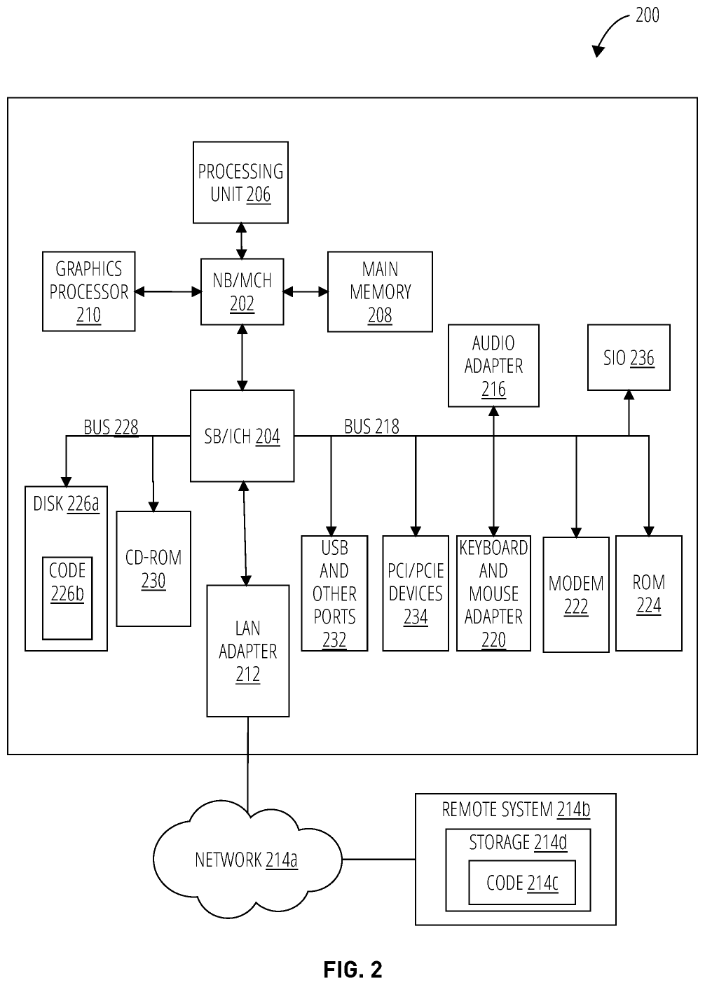

With reference to the figures and in particular with reference to FIG. 1 and FIG. 2, these figures are example diagrams of data processing environments and systems in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 depicts a block diagram of a power supply environment 100 in which illustrative embodiments may be implemented. Power supply environment 100 includes a power supply system 108, and a network/communication infrastructure 110.

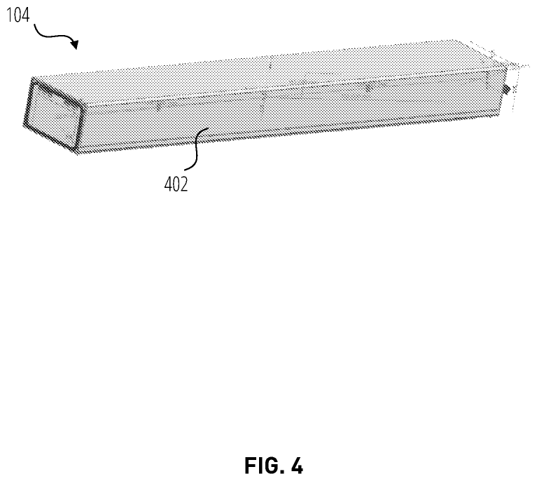

The power supply system 108 may include a plurality of battery energy storage systems 106 each of which may include a plurality of modules 104 each comprising a plurality of cells 102. The cells 102 are hollow core cylindrical cells in accordance with one or more embodiments. In an illustrative embodiment, hollow core cells may be stacked on top of each other vertically to generate the module 104. The cells may also be top terminal prismatic cells in one or more other embodiments and may be stacked with terminals facing one direction and bus bars connecting the terminals together. Of course, this is not meant to be limiting as other cells may be obtained in view of the descriptions herein. In an example aspect, a module comprising 10 hollow core cells has an output voltage of 32V and an energy output of 42 kWh as shown in FIG. 1. According to one example aspect, the module 104 is configured to include a cuboid housing in which the plurality of cylindrical hollow core cells 102 are placed (See FIG. 4). A plurality of the modules can be stacked adjacent to each other in the battery energy storage system 106.

Network/communication infrastructure 110 is the medium used to provide communications links between various devices, battery modules, databases and computers connected together within power supply environment 100. Network/communication infrastructure 110 may include connections, such as Controller Area Network (CAN) Bus connections, Programmable Logic Controllers (PLC), wires, wireless communication links, etc.

The cells 102 may comprise a jelly roll defining an outer radius; a hollow core comprising an inner housing that defines an inner radius, and an outer housing defining a height of the cell 102. In an aspect, the material of the hollow core may comprise aluminum. In another aspect, an outer diameter of the cell is greater than 100 mm. Further, end caps of the cell 102 may comprise a plurality of terminals 138 and one or more ports 140, the one or more ports 140 being operable to perform in-situ manufacturing of the cell 102. The cell 102 may further comprise on or more vents operable to dispel vent gas and vent debris during a venting event.

A dashboard 120 and a dashboard application 128 may be part of or separate from the power supply system 108. The dashboard application 128 may be operable to control parameters of the power supply system 108 including, for example, which battery energy storage systems 106 are in operation in the power supply system 108.

Clients or servers are only example roles of certain data processing systems connected to network/communication infrastructure 110 and are not intended to exclude other configurations or roles for these data processing systems or to imply a limitation to a client-server architecture. Server 112 and server 114 couple to network/communication infrastructure 110 along with storage unit 116. Software applications, such as embedded software applications may execute on any computer or processor or controller in power supply environment 100. Client 118, dashboard 120 may also be coupled to network/communication infrastructure 110. Client 118 may be a remote computer with a display. A data processing system, such as server 112 or server 114, or clients (client 118, dashboard 120) may contain data and may have software applications or software tools executing thereon.

As another example, an embodiment can be distributed across several data processing systems and a data network as shown, whereas another embodiment can be implemented on a single data processing system within the scope of the illustrative embodiments. Data processing systems (server 112, server 114, client 118, dashboard 120) also represent example nodes in a cluster, partitions, and other configurations suitable for implementing an embodiment.

Client application 126, dashboard application 128, or any other application such as server application 122 may implement an embodiment described herein. Any of the applications can use data from power supply system 108 and to partially or fully perform one or more processes described herein. The applications can also obtain data from storage unit 116 for power supply and preemptive thermal management purposes. The applications can also execute in any of data processing systems (server 112 or server 114, client 118, dashboard 120).

Server 112, server 114, storage unit 116, client 118, dashboard 120, may couple to network/communication infrastructure 110 using wired connections, wireless communication protocols, or other suitable data connectivity. Client 118, and dashboard 120 may be, for example, mobile phones, personal computers, or network computers.

In the depicted example, server 112 may provide data, such as boot files, operating system images, and applications to client 118, and dashboard 120. Client 118, and dashboard 120 may be clients to server 112 in this example. Client 118, and dashboard 120 or some combination thereof, may include their own data, boot files, operating system images, and applications. Power supply environment 100 may include additional servers, controllers, clients, and other devices that are not shown. FIG. 1 is intended as an example, and not as an architectural limitation for the different illustrative embodiments.

With reference to FIG. 2, this figure depicts a block diagram of a data processing system in which illustrative embodiments may be implemented. Data processing system 200 is an example of a computer, such as client 118, dashboard 120, server 112, or server 114 in FIG. 1, or another type of device in which computer usable program code, embedded code or instructions implementing the processes may be located for the illustrative embodiments.

Data processing system 200 is described as a computer only as an example, without being limited thereto. Implementations in the form of other devices may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to North Bridge and memory controller hub (NB/MCH) 202 through an accelerated graphics port (AGP) in certain implementations.

In the depicted example, local area network (LAN) adapter 212 is coupled to South Bridge and input/output (I/O) controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and input/output (I/O) controller hub (SB/ICH) 204 through bus 218. Hard disk drive (HDD) or solid-state drive (SSD) 226a and CD-ROM 230 are coupled to South Bridge and input/output (I/O) controller hub (SB/ICH) 204 through bus 228. PCI/PCIe devices 234 may include, for example, Ethernet adapters, add-in cards, and PC cards for notebook computers. PCI uses a card bus controller, while PCle does not. Read only memory (ROM) 224 may be, for example, a flash binary input/output system (BIOS). Hard disk drive (HDD) or solid-state drive (SSD) 226a and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and input/output (I/O) controller hub (SB/ICH) 204 through bus 218.

Memories, such as main memory 208, read only memory (ROM) 224, or flash memory (not shown), are some examples of computer usable storage devices. Hard disk drive (HDD) or solid-state drive (SSD) 226a, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices.

Instructions for the operating system, and applications or programs, (such as application 122, or client application 126 or dashboard application 128) are located on storage devices, such as in the form of codes 226b on Hard disk drive (HDD) or solid-state drive (SSD) 226a, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory (ROM) 224, or in one or more peripheral devices.

Furthermore, in one case, code 226b may be downloaded over network 214a from remote system 214b, where similar code 214c is stored on a storage device 214d in another case, code 226b may be downloaded over network 214a to remote system 214b, where downloaded code 214c is stored on a storage device 214d.

The hardware in FIG. 2 may vary depending on the implementation. Other internal hardware or peripheral devices, such as flash memory, equivalent non-volatile memory, or optical disk drives and the like, may be used in addition to or in place of the hardware depicted in FIG. 2. In addition, the processes of the illustrative embodiments may be applied to a multiprocessor data processing system.

A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub (NB/MCH) 202. A processing unit may include one or more processors or CPUs.

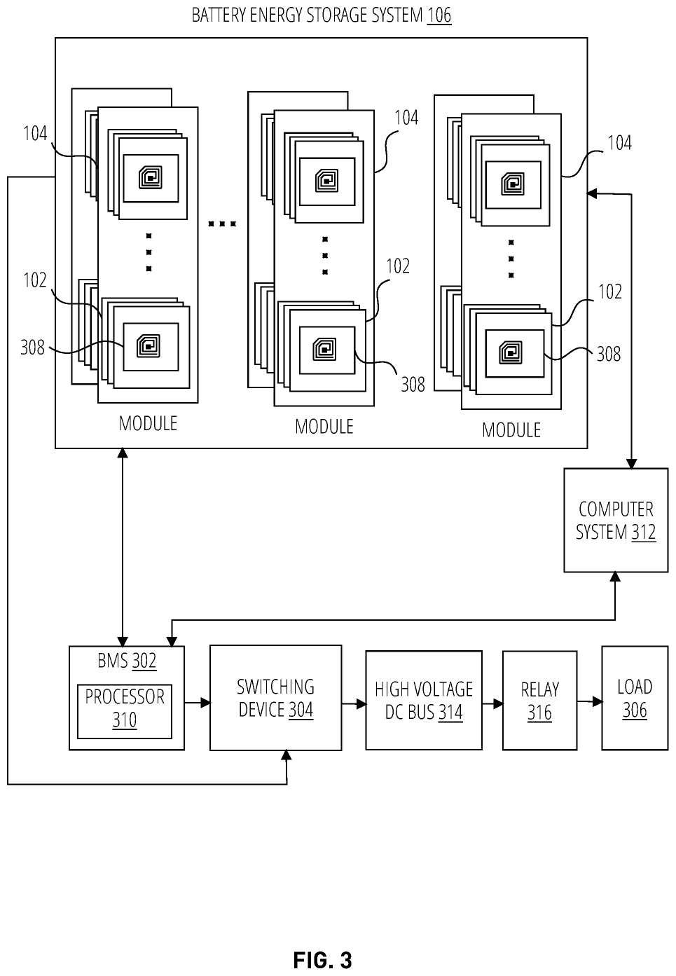

Turing to FIG. 3, a block diagram of a battery energy storage system 106 is shown. The battery energy storage system 106 may comprise a plurality of modules 104, which each comprise a plurality of cells 102 which may be housed in the modules 104. The cells may be hollow core cylindrical cells or top terminal prismatic cells. The battery energy storage system 106 further comprises a battery management system, BMS 302. Each cell 102 may comprise one or more busbar and/or on-cell electronics 308 such as voltage sensors, pressure sensors or temperature sensors configured to measure a state of the cells 102. The busbar and/or on-cell electronics 308 may be an ASIC or IC chip set mounted directly to busbars to measure characteristics of the cells 102. When mounted directly to the busbars, the cells 102 may be balanced via the busbar electronics. A two-wire communication to a BMS 302 or central controller may also be achieved. The busbar and/or on-cell electronics 308 may alternatively be configured as a foil disposed or wrapped on a portion of the outer housing 136 or hollow core 134 or end cap of the cell 102 or on a control board which may receive and/or send data from and/or to the BMS 302 respectively. The busbar and/or on-cell electronics 308 may measure the characteristics such as voltage, current, temperature, SOC (State of Charge), SOH (State of Health), or other state of the cells 102.

The BMS 302 may be configured to communicate with the busbar and/or on-cell electronics 308 or a control board of each cell 102. One or more processors (processor 310, or a processor of computer system 312) may be used in a number of configurations to enable the performance of one or more processes or operations described herein. The battery energy storage system 106 may also comprise a switching device 304 which may be controlled to operatively couple a load 306 to power from the battery energy storage system 106 through a relay 316. The switching device 304 may comprise relays or contactors configured to couple power from the battery energy storage system 106 or a module 104 or a row of modules to the load 306. The switching device 304 may also comprise a controller or may receive instructions from another controller such as the BMS 302 to control and switch on a preset operational mode according to predetermined criteria. In alternative aspects, an external power supply system such as a grid 144 or solar power system 142 may be coupled to the battery energy storage system 106 for one or more power supply processes.

The BMS 302 may monitor and control the performance of the cells 102, modules 104, and/or battery energy storage system 106. The BMS 302 may monitor several cell-level and/or module level characteristics such as cell current, impedance, voltage, and temperature. The BMS 302 may have non-volatile memory such that data may be retained when the BMS 302 is in an off condition. Retained data may be available upon the next cycle. The busbar and/or on-cell electronics 308 may transfer signals in analog or digital form to the BMS 302. In some embodiments, the busbar and/or on-cell electronics 308 may be at least partially integrated into the BMS 302 and the BMS 302 may handle the processing of raw signals.

FIG. 4 illustrates a module 104 in accordance with one or more embodiments. The module 104 may be configured to include a rigid module housing 402 which may in some cases be cuboid. A plurality of cells such as cylindrical hollow core cells 102 are disposed inside the module 104. In one aspect, the vents of the cells 102 point in a same direction such that vent gas and material are dispelled through a common conduit.

In an aspect, the module may be completely welded closed for sealing and structure, with a separation of electrical and cooling structures on one end of the module 104 and abuse and venting structures on the other end, allowing the ability to repair modules after an event after a major cell venting failure.

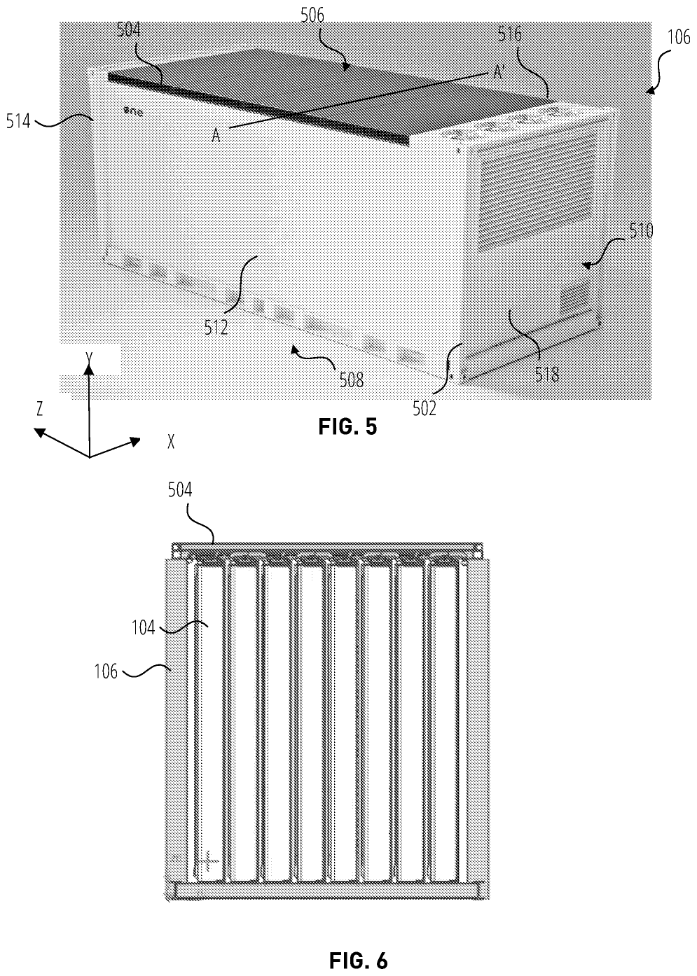

FIG. 5 illustrates a perspective view of a battery energy storage system 106 constructed to prioritize safety, module access and service. The battery energy storage system 106 comprises a housing 502, a roof 504 disposed at a top portion 506 of the battery energy storage system 106, a bottom portion 508 opposite the top portion 506, and a service end 510 from which the battery energy storage system 106 is serviced. As shown in FIG. 5, the roof 504 may be disposed perpendicular to the Y-axis. Further, the housing is configured to make the modules 104, disposed vertically (the longest dimensions are parallel to the Y-axis) in the battery energy storage system 106, inaccessible from three sidewalls by, for example, designing the three sidewalls to include no openings or doors that lead into an interior of the battery energy storage system 106. This may enable the battery energy storage system 106 to be placed near each other and to protect the modules from flooding and inclement weather conditions. The three sidewalls are a first sidewall 512 which is parallel to the YZ plane, the second sidewall 514 which is parallel to the XY plane and the third sidewall 516 which is also parallel to the YZ plane and on an opposite side of the first sidewall 512. The fourth sidewall 518 is disposed on a service end 510 of the battery energy storage system 106 opposite the second sidewall 514.

FIG. 6 illustrates a cross section A-A′ of the battery energy storage system 106 of FIG. 5 showing a plurality of modules 104 disposed vertically in the battery energy storage system 106.

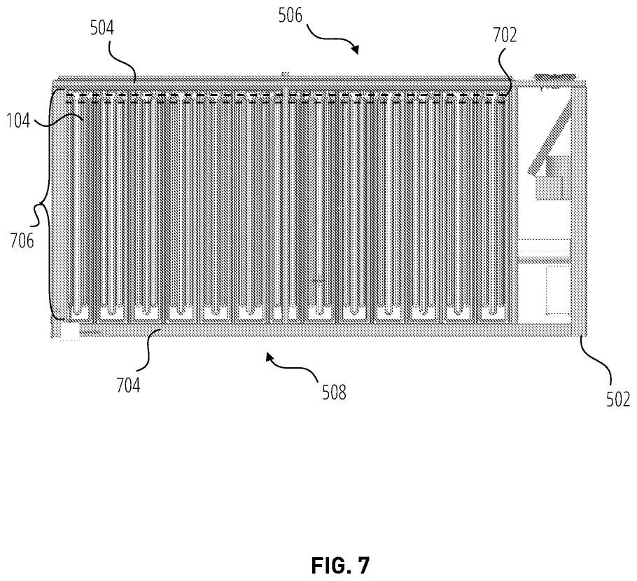

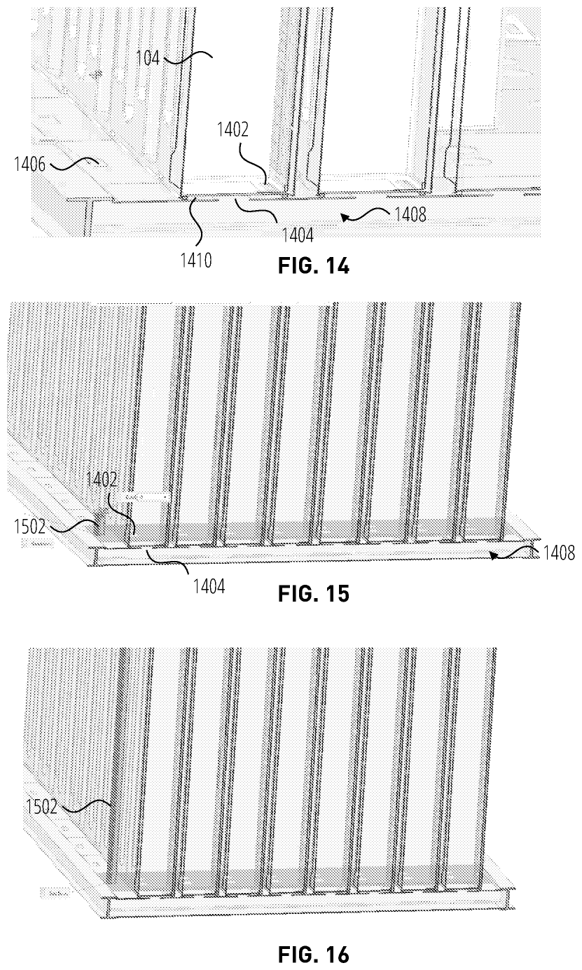

A structure of the battery energy storage system 106 is further illustrated by FIG. 7 which shows that battery energy storage system 106 comprises the housing 502, a top flange disposed at the top portion 506, a bottom flange 704 including a plenum 1408 (or cavity, see FIG. 14), disposed at a bottom portion 508 of the battery energy storage system 106.

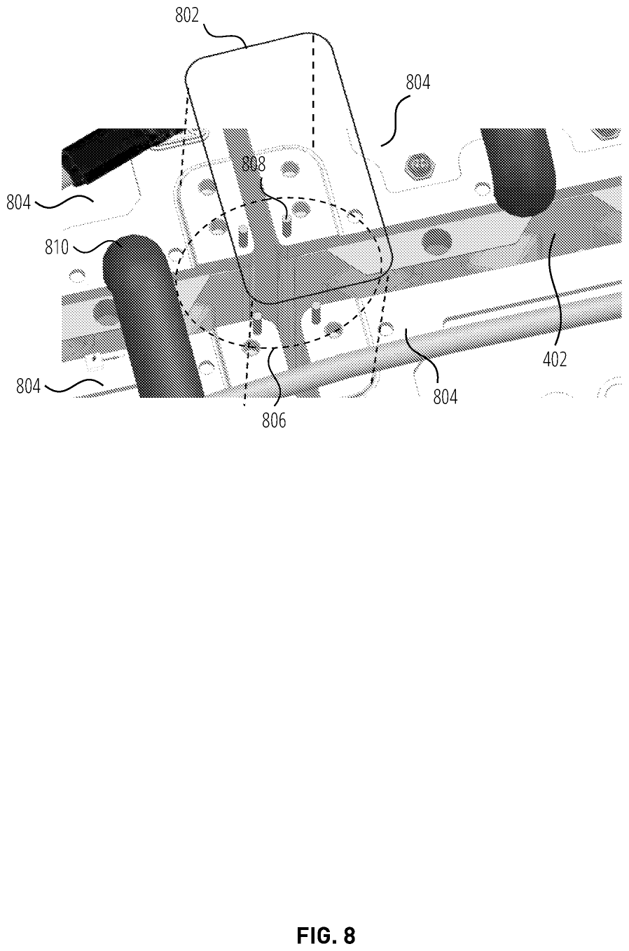

The battery energy storage system 106 further comprises a middle web 706 disposed between the top flange 702 to the bottom flange 704, the middle web 706 being defined by a plurality of modules 104 disposed vertically in the housing 502, each module 104 of the plurality of modules 104 comprising a module housing 402 and a plurality of cells 102. In another aspect, the module 104 comprises more than 50 cells, such as more than 90 cells 102, and each cell 102 may provide an output voltage of 3.2V, for example. The module housing 402 is configured to be rigid. In an aspect, the top flange 702, the bottom flange 704, and the middle web 706 define an I-beam structure of the battery energy storage system 106. More specifically, the modules are connected together at the top portion 506 to generate the top flange 702 and connected to the bottom flange 704 at the bottom portion 508 to define the I-beam structure, with a height of the modules defining a spacing between the top flange 702 and the bottom flange 704. Thus, the top flange 702 comprises a top portion of the plurality of vertically disposed modules 104, and a plurality of connecting plates 802, as shown in FIG. 8, that join a plurality of adjacent modules 804 at the top portion 506. In an aspect, four adjacent modules 804 are joined together at corners of the adjacent modules 804, or at an intersection area 806 using the connecting plate 802. Further pins 808 and/or bolts may be used to aid the joining.

In an aspect, each module 104 of the plurality of modules 104 is directly joined at the top portion 506 to at least one other module 104 via a connecting plate 802. Further, each module may be directly or indirectly joined to all other modules 104 of the plurality of modules 104 through the connecting plates 802.

In another aspect, the plurality modules 104 are removably attached to the bottom flange (such as inserted into the bottom flange 704 via pins). By virtue of the attachment of the modules 104 to the bottom flange 704, the connecting of the modules 104 together at the top portion 506 to define the top flange 702, and the rigidity of the module housings 402, a honeycomb structure of the battery energy storage system is produced that provides bending stiffness or a predetermined resistance to bending of the battery energy storage system 106 upon lifting the battery energy storage system 106 from one place to another, such as onto a truck. Thus, a practice of using bolts or other connection means to couple the parts of the housing 502 together to provide a fully self-supported structural container, as may be practiced in conventional systems, is obviated. In an aspect, the module housing 402 may become the load path upon lifting of the battery energy storage system 106. Therefore, rather than having to design the housing 502 of the battery energy storage system 106 to make it strong and stiff enough to withstand bending upon a lifting event, the incorporation of vertical modules along with the top flange 702 and removable attachment to the bottom flange 704, provides the strength and obviates a complex housing structure that can withstand lifting of the battery energy storage system 106. Bolting of the modules 104 into the battery energy storage system 106 may thus be obviated, allowing easy retrieval of the modules from battery energy storage system 106 via the top portion 506. Upon lifting the container, for example at four points on the bottom flange 704, the load tis driven through the modules 104 to ensure that the container stays stiff enough for that lift event.

A stiffness of the battery energy storage systems may be proportional to the height (in the Y-axis) of the battery energy storage system. Unlike in conventional systems, wherein contribution of conventional modules to the stiffness of the conventional battery energy storage system may not be observed due to the housing of the system being designed to be fully self-supporting, the contribution of the modules 104 to the stiffness of the battery energy storage system 106 is observed.

In another aspect, each module 104 comprises a handle 810 at the top portion, the handle is engageable to retrieve the module from the battery energy storage system.

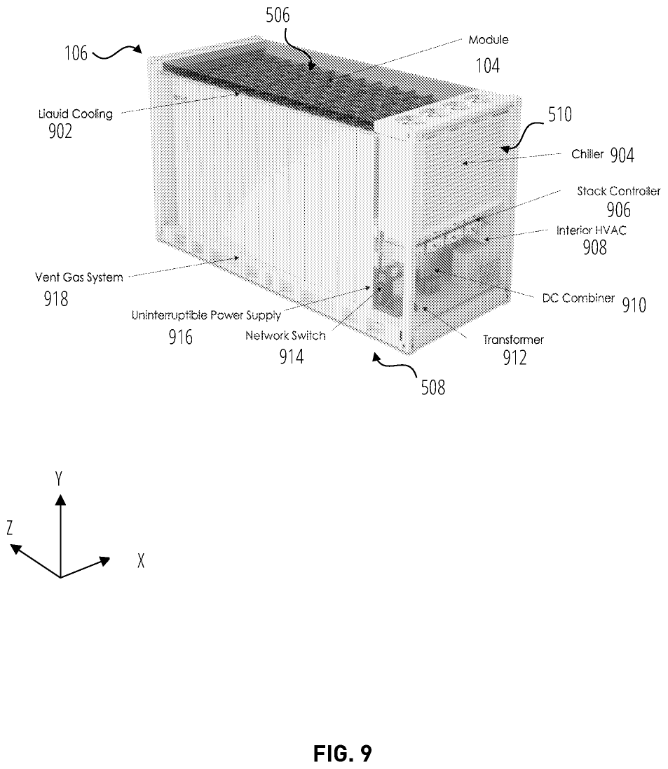

FIG. 9 shows contents of the battery energy storage system 106 according to an illustrative embodiment. As shown in FIG. 9, the battery energy storage system further comprises a liquid cooling 902 and a chiller 904 that cools the modules 104, a stack controller 906 that turns the system on or off, an interior HVAC 908 operable to condition the air inside the battery energy storage system, an optional DC combiner 910, a transformer 912 operable to provide power to auxiliary components, a network switch 914 that handles IO (input/outpit) for the controls, an uninterruptible power supply 916, and a vent gas system 918.

As discussed herein, the modules are arranged vertically (in the Y-direction) in the battery energy storage system 106. By virtue of the vertical arrangement, the modules 104 can be accessed from a top of the battery energy storage system which may be sealed and opened when necessary to allow for module extraction. In an embodiment of the battery energy storage system 106, electrical and coolant connections are located at the top of the modules and the roof 504 is automatically triggered to open to allow for vent gas release during thermal runway.

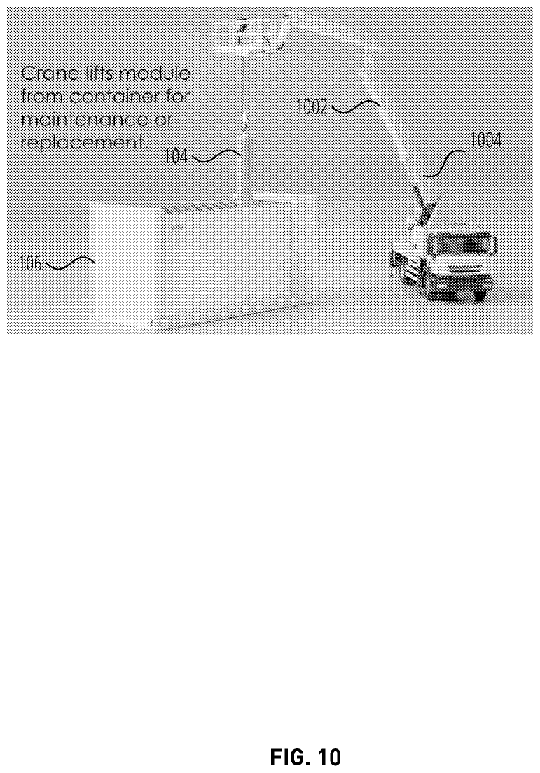

FIG. 10 is a sketch illustrates a method of inserting or removing a module from the battery energy storage system 106. A removal or insertion device such as a crane 1002 or forklift engages the handle 810 to lift the module for removal or insertion.

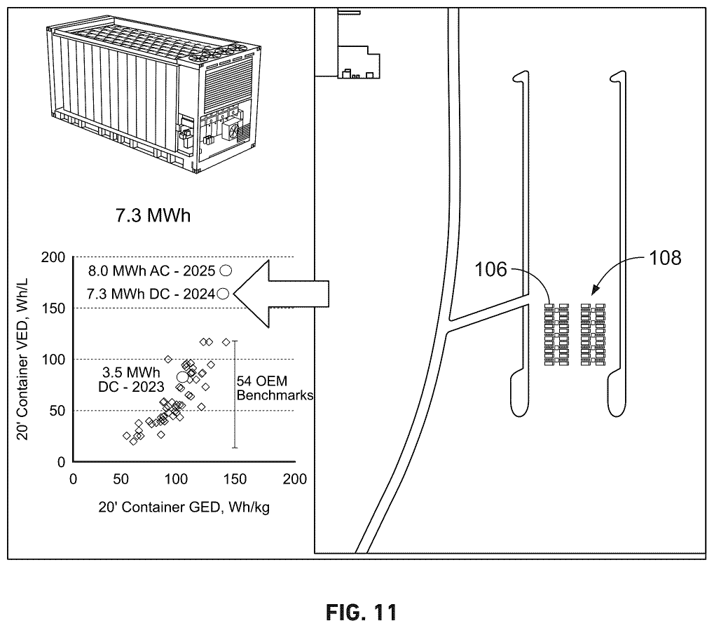

FIG. 11 illustrates a layout of a plurality of battery energy storage systems 106 in accordance with an illustrative embodiment. Each battery energy storage system 106 of the plurality of battery energy storage systems 106 comprises a housing 502, a top flange 702 disposed at a top portion 506 of the battery energy storage system 106, a bottom flange 704 including a plenum 1408 disposed at a bottom portion 508 of the battery energy storage system, a middle web 706 disposed between the top flange 702 and the bottom flange 704, the middle web 706 being defined by a plurality of modules 104 disposed vertically in the housing. As discussed herein, each of the battery energy storage systems 106 may comprise at least three vertical sidewalls (first sidewall 512, second sidewall 514, and third sidewall 516) which are constructed to provide no access to the plurality of modules from the at least three vertical sidewalls. By virtue of the at least three vertical sidewalls sealing the modules 104 from external sideways access, with access being provided from the roof, the plurality of battery energy storage systems 106 can be arranged in close proximity to each other without giving up the ability to access the modules in other ways (from the top flange 702) and without giving up the ability to service the battery energy storage system 106 from the service end 510. The close arrangement of the battery energy storage systems 106 allows the generation of a power supply system 108 of battery energy storage systems 106 that provides an energy density of at least 700 MWh/acre while still observing normal day to day operation, with regards to for example, module insertion, removal, and servicing. In an embodiment the battery energy storage systems 106 can be arranged such that space between two adjacent battery energy storage systems 106 can accommodate one person or two persons, or no person, for example.

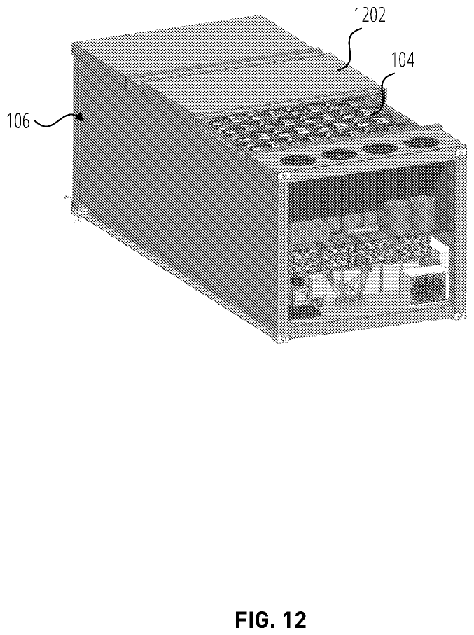

FIG. 12 illustrates a battery energy storage system 106 comprising a roof that is configured as a nested panel structure 1202 which can be engaged to easily open or close the battery energy storage system 106 to provide access to the modules 104.

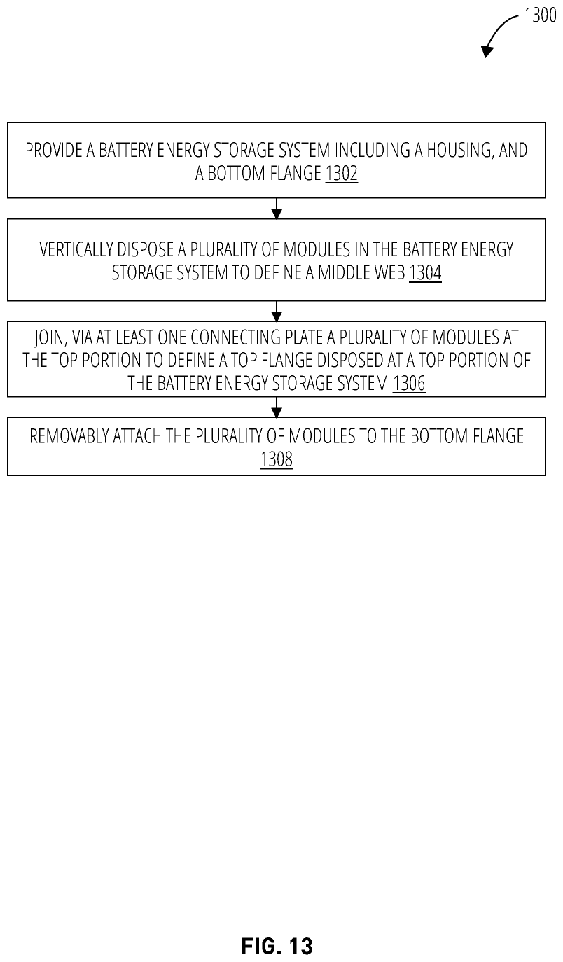

FIG. 13 is a flowchart illustrating a method 1300 in accordance with an illustrative embodiment. In block 1302, a battery energy storage system 106 is provided including a housing 502, and a bottom flange 704 that comprises a plenum. The bottom flange 704 is disposed at a bottom portion 508 of the battery energy storage system 106.

In block 1304, a plurality of modules 104 are vertically disposed in the battery energy storage system 106 to define the middle web 706, each module of the plurality of modules comprising a module housing 402 and a plurality of cells 102.

In block 1306, at least one connecting plate is used to join a plurality of modules at the top portion 506 to define a top flange of the battery energy storage system.

In block 1308, the plurality of modules 104 are removably attached to the bottom flange, for example, by the using of pins in the modules that are inserted into the bottom flange 704, or holes in the modules that receive corresponding pins in the bottom flange 704, or otherwise other removable attachments means. The top flange, the bottom flange, and the middle web thus define an I-beam structure of the battery energy storage system 106.

FIG. 14 depicts a zoomed in view of a cross section of the battery energy storage system 106 illustrating a vent gas system 918 in accordance with an illustrative embodiment. The vent gas system 918 may be part of a battery energy storage system 106 that comprises the housing 502, the bottom flange 704 including the plenum 1408, and an escape duct 1502 connected to the bottom flange 704. A plurality of modules 104 are disposed vertically into the battery energy storage system 106, with each module 104 of the plurality of modules 104 comprising a module housing 402, and a plurality of cells 102. In an aspect, the cells 102 can be cylindrical hollow core cells.

The module 104 may include a module opening 1402 at a bottom portion of the module 104. The cells 102 may each comprise a vent (not shown) through which vent gas and vent debris are disposed to the bottom flange 704 through the module opening 1402. Thus, vent gas can be exhausted directly to an exterior of the battery energy storage system 106 through the dedicated vent gas system 918.

As shown in FIG. 14, the bottom flange 704 comprises the bottom flange opening 1404 which provides access into the plenum 1408, and through which the vent gas and vent debris from the module opening 1402 pass into the plenum 1408. When the module 104 is inserted, the module opening 1402 comes in close proximity to the bottom flange opening 1404 to define a sealed airspace 1410 which is sealed at least partly by the weight or mass of the module 104.

Responsive to a venting event of one or more cells that produces vent gas and vent debris, the vent debris may be held in the plenum 1408 and the vent gas may be pushed through the escape duct 1502 (See FIG. 15 and FIG. 16 which show different heights of the escape duct 1502) by virtue of a minimized volume of the plenum. The escape duct 1502 is connected to the plenum 1408 through the escape duct opening 1406 (See FIG. 14 and FIG. 15).

In an aspect, the design of the vent gas system 918 may reduce or eliminate the opportunity to accumulate enough hydrogen for a significant explosion. Further, air or oxygen in the vent gas system 918 prior to a venting event may be pushed out of the battery energy storage system 106 by virtue of the minimized volume of the plenum 1408. As soon as the vent gases move into the plenum 1408, the oxygen may be purged out of the vent gas system 918, and the system may become outside the flammability threshold for hydrogen gas. As vent gases travel through the escape duct 1502 or a pipe of the vent gas system 918 that leads to an exterior of the battery energy storage system 106, the vent gases are cooled and dispelled from the top portion 506 of the battery energy storage system 106. This may eliminate or reduce the need for a fire suppression system, which can lead to significant cost savings and provide passive safety.

In an aspect, the minimized volume of a plenum 1408 of a 20-foot battery energy storage system 106 may be 150-250 liters of airspace, and each cell 102 can expel about 200 liters (+/−50%) of flammable vent gas, thus providing little space for accumulation of combustible gases. The illustrative embodiments recognize that in conventional system, an available comparable volume of venting airspace may be, for example, 20,000 to 25,000 liters of airspace for a 20-foot container which is two orders of magnitude higher. Further, the illustrative embodiments recognize that a conventional system may handle hydrogen generation in a container by the use of explosion valves, deflagration points, or active ventilation fans to attempt to be below a combustion threshold.

In yet another aspect, the rigid housings of the modules are configured to be module cavities which are separate or separable from internal components of the module such that the internal components are insertable into the battery energy storage system 106 by inserting them into the module cavities. Thus, another honeycomb structure may be realized where the internal components and the module cavities define the middle web 706.

In a further aspect, each module opening 1402 of the plurality of modules has a corresponding bottom flange opening 1404 in the bottom flange 704. Moreover, the bottom flange 704 may comprise a plurality of plenums 1408 each corresponding to a row of modules in the battery energy storage system 106, and plurality of escape ducts each corresponding to the row of modules in the battery energy storage system. The plurality of escape ducts may be connected to the roof 504 of the battery energy storage system 106 to dispose the vent gas through the roof 504.

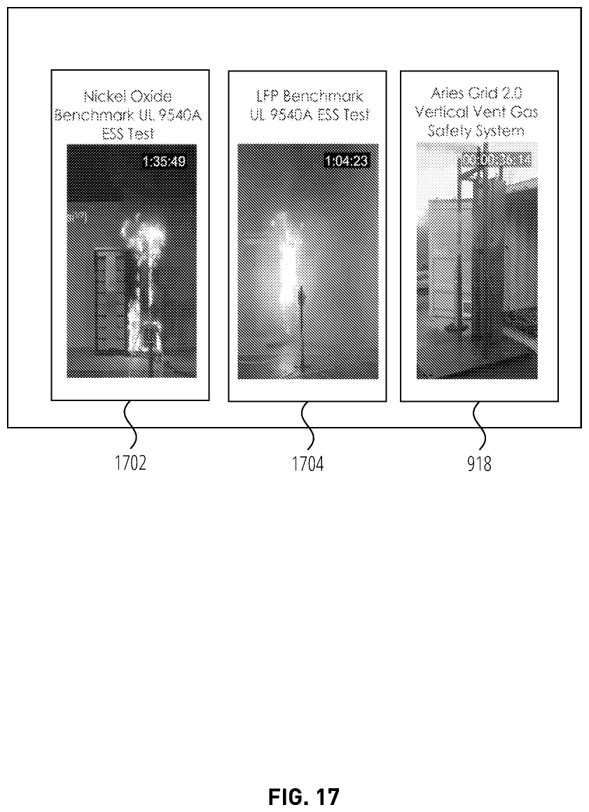

FIG. 17 is a diagram illustrating benchmark testing of different venting systems to demonstrate an effectiveness of a hydrogen vent gas management in accordance with an illustrative embodiment. As shown in FIG. 17 conventional LFP 1704 (Lithium iron phosphate) and Nickel oxide 1702 systems are shown in a Benchmark UL 9540A ESS (Energy Storage System) Test to burn during a cell venting event, whereas the vent gas system 918 disclosed herein safely disposes vent gas outside through the bottom and then to a top portion of the module via dedicated vent channels. The rate at which the different chemistries go into thermal runaway is different as illustrated by the different timestamps showing the difference in the peak intensity points of thermal runaway.

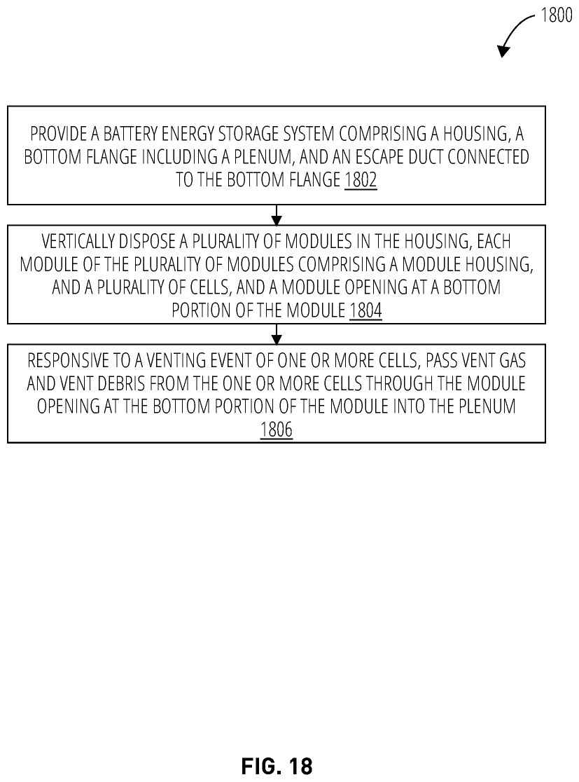

FIG. 18 is a flowchart depicting a method 1800 in accordance with an illustrative embodiment. The method 1800 may begin at block 1802 wherein a battery energy storage system 106 is provided comprising a housing 502, a bottom flange 704 including a plenum 1408, the bottom flange 704 being disposed at a bottom portion 508 of the battery energy storage system and an escape duct 1502 connected to the bottom flange 704.

In block 1804, a plurality of modules 104 are vertically disposed in the housing, each module 104 of the plurality of modules 104 comprising a module housing 402, and a plurality of cells 102 which may be cylindrical hollow core cells, and a module opening at a bottom portion of the module 104.

In block 1806, vent gas and vent debris are passed, responsive to a venting event of one or more cells of the module 104, from the one or more cells through a module opening 1402 at the bottom portion 508 of the module 104 into the plenum 1408. Thereafter, the vent gas is passed to an exterior of the battery energy storage system 106 through the escape duct 1502 while the vent debris stays in the plenum 1408.

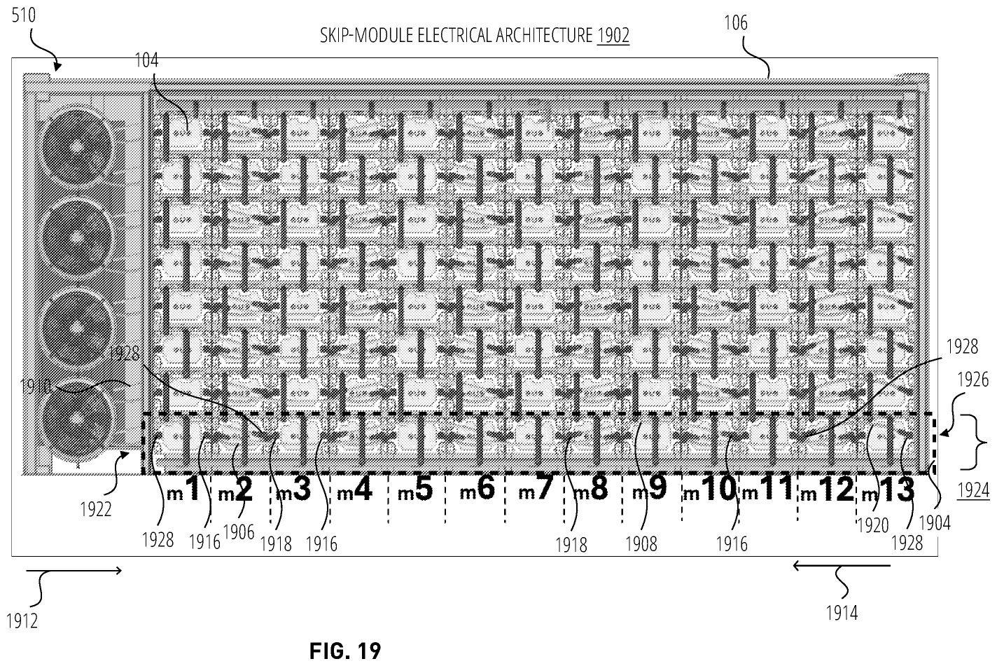

Turning now to FIG. 19, an architecture for electrically coupling modules of the battery energy storage system 106 is disclosed. The architecture may enable the generation of a battery energy storage system 106 comprising a housing 502, a plurality of modules 104 disposed vertically in the housing 502, each module of the plurality of modules comprising a module housing 402 and a plurality of cells 102 disposed in the module housing 402. The plurality of modules are arranged in at least one row, in a skip-module electrical architecture 1902 of odd designated modules (such as, for example, m1, m3, m5, m7, m9, m11, and m13) interspersed in the at least one row with even designated modules (such as, for example, m2, m4, m6, m7, m8, m10, m12) to define two sets strings of modules. The two sets strings of modules are interlaced to generate two series strings of modules that maintain consistent connector lengths in the battery energy storage system.

More specifically, the skip-module electrical architecture 1902 or interlacing may be generated by following a connection strategy wherein in a first direction 1912 starting from a first end 1922 of a first row 1924 towards a second end 1926 opposite the first end 1922, a terminal 1916 of each odd designated module (e.g., m1), the terminal comprising a first polarity (e.g., positive polarity), is electrically coupled to another terminal 1918 of a nearest odd designated module (e.g., m3) using a first connector 1906, the another terminal 1918 comprising a second polarity different from the first polarity (e.g., negative polarity).

Further, in a second direction 1914 opposite the first direction 1912, the terminal 1916 of each even designated module (e.g., m10), the terminal 1916 comprising the first polarity, is electrically coupled to another terminal 1918 of a nearest even designated module (e.g., m8) using a second connector 1908, the another terminal 1918 comprising the second polarity. The lengths the first connectors 1906 in the first row are substantially the same and the lengths of the second connectors 1908 in the first row 1924 are substantially the same. The lengths are chosen to minimize variations in resistances across the plurality of modules. The illustrative embodiments recognize that the skip-module electrical architecture 1902 may obviate the use of long return jumpers/connectors from the second end 1926 to the first end 1922 that would have been used were a single series string of modules to be realized, due to the interweaving of the series strings. Thus, as opposed to one series string of modules, two series strings may be generated such that every other module is connected electrically to an independent series string.

More specifically, a resistance of the battery energy storage system 106 may be driven by cable/connector length as a dominating factor. A goal may be to have similar high voltage connections that can reduce the variation of internal resistances among the modules, and to get all the electrical connections back to the service end 510 of the battery energy storage system 106. This may enable the three-sided system where access to the modules from the three first sidewall 512, second sidewalls 514 and third sidewall 516 is obviated. Further, by making connectors similar in length, similar resistance may be generated across the modules, and in effect similar voltage drops as opposed to less voltage drop on the short connectors and a comparatively large voltage drop on a long connector.

In an aspect, at the first end 1922 or the second end 1926 of the first row 1924, a remaining terminal 1928 of a remaining even or odd designated module (modules with an available unconnected terminal) is electrically coupled to a remaining terminal 1928 of an adjacent module, or to a load at the service end 510, such that all even and odd designated modules in the first row are electrically coupled in series. For example, specifically, a third connector 1910 is used to electrically couple a remaining terminal 1928 of m2 to the load.

In another example, a fourth connector 1920 is used to electrically couple the remaining terminal 1928 of m13 to the remaining terminal 1928 of adjacent module m12. This connection strategy may reduce or to equalize as much as possible, the cable lengths in the container, thereby minimizing a variation in the resistances across the modules. In an example, assuming a first cable length is normalized 1×, a maximum cable length me be no more than 3× and a minimum cable length would be no less than 0.3×.

According to another aspect, the plurality of modules is disposed in the battery energy storage system to define an n x m grid, wherein n and m are positive integers, n defines a row of modules in the battery energy storage system 106 and m defines a column of modules in the battery energy storage system 106. For example, 2<n<100 and 2<m<100, or 5<n<50 and 5<m<50, or 5<n<20 and 5<m<20.

According to yet another aspect, the plurality of modules in the first row 1924 are electrically coupled in series in the first row, and electrically coupled in parallel to another plurality of series connected modules in a second row. In effect, all rows of series coupled modules may be electrically coupled in parallel with other rows of series coupled modules. Of course, this is not meant to be limiting as other variations may be obtained in light of the descriptions herein.

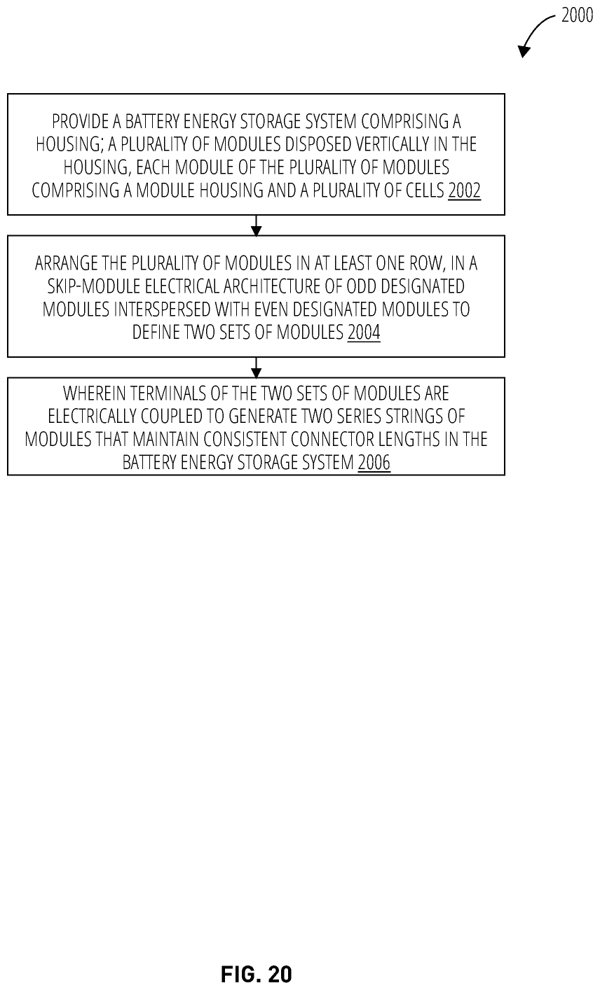

FIG. 20 illustrates methods 2000 of generating a battery energy storage system 106 with a skip-module electrical architecture 1902 in accordance with an illustrative embodiment. In block 2002, a battery energy storage system 106 may be provided comprising a housing 502, a plurality of modules 104 disposed vertically in the housing 502, each module of the plurality of modules comprising a module housing 402 and a plurality of cells 102.

In block 2004, the plurality of modules is arranged in at least one row, in a skip-module electrical architecture of odd designated modules interspersed in the at least one row with even designated modules to define two sets of modules.

In block 2006, the two sets of modules are electrically coupled or interlaced to generate two series strings of modules to maintain consistent connector lengths in the battery energy storage system. In an aspect, at least a first connector 1906, a second connector 1908, a third connector 1910 and a fourth connector 1920 may be used in the skip-module electrical architecture 1902. The lengths of the connectors are chosen to minimize variations in resistances across the plurality of modules.

For the sake of brevity, conventional techniques related to making and using aspects of the disclosure may or may not be described in detail herein. In particular, various aspects of manufacturing and computing systems and specific programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order, or actions can be added, deleted, or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A battery energy storage system comprising:
a housing;
a top flange disposed at a top portion of the battery energy storage system;
a bottom flange including a plenum, disposed at a bottom portion of the battery energy storage system;
a middle web disposed between the top flange and the bottom flange, the middle web being defined by a plurality of modules disposed vertically in the housing, each module of the plurality of modules comprising a module housing and a plurality of cells;
wherein the top flange, the bottom flange, and the middle web define an I-beam structure of the battery energy storage system.

2. The battery energy storage system of claim 1, wherein the plurality of cells are a plurality of cylindrical hollow core cells or top terminal prismatic cells.

3. The battery energy storage system of claim 1, wherein the top flange comprises:
the top portion of the plurality of modules; and
at least one connecting plate that joins a plurality of adjacent modules at the top portion.

4. The battery energy storage system of claim 3, wherein each module of the plurality of modules is directly joined at the top portion to at least one other module.

5. The battery energy storage system of claim 3, wherein each module is directly or indirectly joined to all other modules of the plurality of modules through the at least one connecting plate.

6. The battery energy storage system of claim 3, wherein:
the plurality of adjacent modules are attached to the bottom flange; and
the battery energy storage system is configured to be stiff when lifted by virtue of the at least one connecting plate, the module housing of the plurality of modules, and the bottom flange being designed to define a honeycomb structure of the battery energy storage system that provides a predetermined resistance to bending upon lifting.

7. The battery energy storage system of claim 6, wherein the plurality of adjacent modules are removably attached to the bottom flange.

8. The battery energy storage system of claim 7, the plurality of adjacent modules are attached to the bottom flange by pinning the first plurality of adjacent modules into the bottom flange.

9. The battery energy storage system of claim 6, wherein a stiffness of the battery energy storage systems is proportional to a height of the battery energy storage system.

10. The battery energy storage system of claim 1, wherein each module comprises a handle at the top portion, the handle being engageable to retrieve the module from the battery energy storage system.

11. The battery energy storage system of claim 1, wherein:
at least three vertical sidewalls of the battery energy storage system are constructed to provide no access to the plurality of modules from the at least three vertical sidewalls.

12. The battery energy storage system of claim 1, further comprising:
a roof which is operable to open the battery energy storage system for access to the plurality of modules.

13. The battery energy storage system of claim 12, wherein the roof comprises a nested panel.

14-17. (canceled)

18. A battery energy storage system comprising:
a housing;
a bottom flange including a plenum, disposed at a bottom portion of the battery energy storage system;
an escape duct connected to the bottom flange;
a plurality of modules disposed vertically in the housing, each module of the plurality of modules comprising a module housing, a plurality of cells; and a module opening at a bottom portion of the module;
wherein the plurality of cells each comprise a vent through which vent gas and vent debris are disposed to the bottom flange through the module opening,
wherein responsive to a venting event of one or more cells, the vent debris is held in the bottom flange and the vent gas is pushed through the escape duct by virtue of a minimized volume of the plenum.

19. The battery energy storage system of claim 18, wherein the plurality of cells are a plurality of cylindrical hollow core cells or top terminal prismatic cells.

20. The battery energy storage system of claim 18, wherein:
the minimized volume of the plenum is 150-250 liters of airspace, and each of the one or more cells expel about 200 liters (+/−50%) of vent gas.

21. (canceled)

22. The battery energy storage system of claim 18, wherein:
the bottom flange further comprises a bottom flange opening for the module that opens into the plenum, and through which the vent gas and vent debris from the module opening pass into the plenum.

23. The battery energy storage system of claim 22, wherein the bottom flange opening and the module opening open into a sealed airspace to provide gas sealing when the module and the bottom flange are brought together.

24. The battery energy storage system of claim 22, wherein each module opening of the plurality of modules has a corresponding bottom flange opening in the bottom flange.

25-32. (canceled)

33. A battery energy storage system comprising:
a housing;
a plurality of modules disposed vertically in the housing, each module of the plurality of modules comprising a module housing and a plurality of cells disposed in the module housing;
the plurality of modules are arranged in at least one row, in a skip-module electrical architecture of odd designated modules interspersed in the at least one row with even designated modules to define two sets of modules;
wherein the two sets of modules are electrically coupled to generate two series strings of modules that maintain consistent connector lengths in the battery energy storage system.

34-50. (canceled)
